(19) United States
(12) Patent Application Publication
(10) Pub. No.: US 2020/0300168 A1
(43) Pub. Date: Sep. 24, 2020

(54) BACKUP SYSTEM FOR DEMAND FUEL PUMPING SYSTEM

(71) Applicant: United Technologies Corporation, Farmington, CT (US)

(72) Inventors: Neal R. Herring, East Hampton, CT (US); Michael K. Ikeda, West Hartford, CT (US); Peter Cocks, South Glastonbury, CT (US)

(21) Appl. No.: 16/803,095

(22) Filed: Feb. 27, 2020

Related U.S. Application Data
(60) Provisional application No. 62/821,025, filed on Mar. 20, 2019.

(51) Int. Cl. F02C 7/236

(52) U.S. Cl. CPC F02C 7/236; F05D 2220/32

(57) ABSTRACT

A fuel system for a gas turbine engine includes a primary fuel pump providing fuel flow during engine operation and a primary electric motor coupled to the primary fuel pump for driving the primary fuel pump during engine operation. A secondary system provides fuel flow in the absence of fuel flow from the primary fuel pump.

### CROSS-REFERENCE TO RELATED APPLICATIONS

This application claims priority to U.S. Provisional Application No. 62/821,025 which was filed on Mar. 20, 2019.

### BACKGROUND

A gas turbine engine typically includes a fan section, a compressor section, a combustor section and a turbine section. Air entering the compressor section is compressed and delivered into the combustion section where it is mixed with fuel and ignited to generate a high- energy exhaust gas flow. The high-energy exhaust gas flow expands through the turbine section to drive the compressor and the fan section. The compressor section typically includes low and high pressure compressors, and the turbine section includes low and high pressure turbines.

Fuel supplied to the combustor is provided by a mechanical pump driven by a rotating shaft of the engine. The mechanical pump is reliable and supplies fuel in proportion to engine speed. The minimum capacity of the mechanical pump is sized such that sufficient fuel is provided for high power conditions and/or engine starting. Excess fuel not needed is recirculated within the fuel system or back to the fuel tank. The fuel is further utilized as a coolant for other systems of the engine. Recirculation of fuel increases the temperature of the fuel and thereby reduces the available capacity to absorb heat from other systems. The capacity of the fuel to absorb heat from other systems is further limited by the characteristics of the fuel. At a certain temperature, the fuel begins to degrade and create deposits in the fuel system that can degrade engine performance. Reducing the amount of fuel that is recirculated during engine operation may improve the capacity of the fuel to absorb heat from other systems.

Turbine engine manufacturers continuously seek improvements to engine performance including improvements to thermal, transfer and propulsive efficiencies.

### SUMMARY

A fuel system for a gas turbine engine according to an exemplary embodiment of this disclosure includes, among other possible things, a primary fuel pump providing fuel flow during engine operation and a primary electric motor coupled to the primary fuel pump for driving the primary fuel pump during engine operation. A secondary system provides fuel flow in the absence of fuel flow from the primary fuel pump.

In a further embodiment of a fuel system for a gas turbine engine, the secondary system comprises a secondary drive coupled to the primary fuel pump for driving the fuel pump instead of the electric motor.

In another embodiment of any of the foregoing fuel systems for a gas turbine engine, the secondary drive comprises a hydraulic turbine coupled to the primary pump.

In another embodiment of any of the foregoing fuel systems for a gas turbine engine, a clutch means for selectively coupling the hydraulic turbine is included to drive the primary pump.

In another embodiment of any of the foregoing fuel systems for a gas turbine engine, a hydraulic control valve controls a flow of hydraulic fluid to the hydraulic turbine to control a speed of the hydraulic turbine and thereby the speed of the primary pump and the flow of fuel.

In another embodiment of any of the foregoing fuel systems for a gas turbine engine, secondary system comprises a secondary pump powered by a secondary drive.

In another embodiment of any of the foregoing fuel systems for a gas turbine engine, the secondary drive comprises a hydraulically powered turbine.

In another embodiment of any of the foregoing fuel systems for a gas turbine engine, the secondary drive comprises an air cycle machine driven by a bleed airflow from the engine.

In another embodiment of any of the foregoing fuel systems for a gas turbine engine, a bleed air control valve controls a speed of the air cycle machine.

In another embodiment of any of the foregoing fuel systems for a gas turbine engine, a first valve is included upstream of the secondary pump and a second valve is included downstream of the secondary pump for controlling fuel flow from the secondary pump.

A gas turbine engine according to an exemplary embodiment of this disclosure includes, among other possible things, a fan rotatable within a fan nacelle and a core engine that includes a compressor communicating compressed air to a combustor where compressed air is mixed with fuel and ignited to generate a high-energy gas flow expanded through a turbine. A primary fuel pump provides fuel to the combustor during engine operation. A primary electric motor is coupled to the primary fuel pump for driving the primary fuel pump during engine operation, and a secondary system providing fuel flow in the absence of fuel flow from the primary fuel pump.

In a further embodiment of the foregoing gas turbine engine, the secondary system comprises a hydraulically powered turbine coupled to drive the primary fuel pump instead of the primary electric motor.

In another embodiment of any of the foregoing gas turbines engines, a hydraulic control valve controls a flow of hydraulic fluid to the hydraulic turbine to control a speed of the hydraulic turbine, and thereby the speed of the primary pump and the flow of fuel to the combustor.

In another embodiment of any of the foregoing gas turbines engines, secondary system comprises a secondary pump powered by a secondary drive.

In another embodiment of any of the foregoing gas turbines engines, the secondary drive comprises a hydraulic turbine driven by a flow of fluid.

In another embodiment of any of the foregoing gas turbines engines, the hydraulic turbine comprise an air cycle machine driven by a flow of air bled from the compressor. A bleed air control valve controls a speed of the air cycle machine by varying the flow of air bleed from the compressor.

In another embodiment of any of the foregoing gas turbines engines, a first valve is upstream of the secondary pump and a second valve is downstream of the secondary pump for controlling fuel flow from the secondary pump.

A method of supplying fuel to a combustor of a gas turbine engine according to an exemplary embodiment of this disclosure includes, among other possible things, a primary fuel pump driven by an electric motor to provide a first fuel flow that varies independent of a speed of shaft driven by a turbine of the engine. A second fuel flow is generated with a secondary system in response to the electric motor not driving the primary fuel pump sufficiently to power the engine.

In another embodiment of any of the foregoing gas turbines engines, the second fuel flow is generated with a secondary drive driving the primary fuel pump.

In another embodiment of any of the foregoing gas turbines engines, the second fuel flow is generated with a secondary fuel pump driven by a secondary drive independent of the primary fuel pump.

In another embodiment of any of the foregoing gas turbines engines, the secondary drive comprises an air cycle machine powered by a flow of air bleed from a compressor of the engine.

Although the different examples have the specific components shown in the illustrations, embodiments of this invention are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example gas turbine engine.

FIG. 2 is schematic view of an example fuel system embodiment.

FIG. 3 is a schematic view of another example fuel system embodiment.

### DETAILED DESCRIPTION

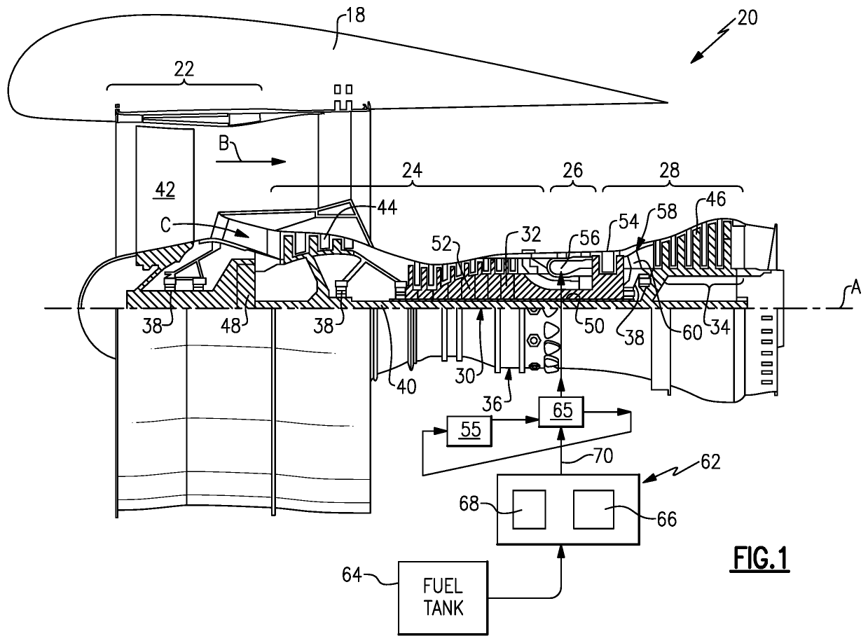

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 drives air along a bypass flow path B in a bypass duct defined within a nacelle 18, and also drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures and low bypass engines.

The exemplary engine 20 generally includes a low speed spool 30 and a high speed spool 32 mounted for rotation about an engine central longitudinal axis A relative to an engine static structure 36 via several bearing systems 38. It should be understood that the various bearing systems 38 may alternatively or additionally be provided at different locations, and the location of bearing systems 38 may be varied as appropriate to the application.

The low speed spool 30 generally includes an inner shaft 40 that interconnects, a first (or low) pressure compressor 44 and a first (or low) pressure turbine 46. The inner shaft 40 is connected to a fan section 22 through a speed change mechanism, which in exemplary gas turbine engine 20 is illustrated as a geared architecture 48 to drive fan blades 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 58 of the engine static structure 36 may be arranged generally between the high pressure turbine 54 and the low pressure turbine 46. The mid-turbine frame 58 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 58 includes airfoils 60 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low pressure compressor 44 and the fan blades 42 may be positioned forward or aft of the location of the geared architecture 48 or even aft of turbine section 28.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1 and less than about 5:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFCT’)”—is the industry standard parameter of 1 bm of fuel being burned divided by 1 bf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7 ° R)]^{0.5}. The “Low corrected fan tip speed” as disclosed herein according to one non-limiting embodiment is less than about 1150 ft/second (350.5 meters/second).

The example gas turbine engine includes the fan section 22 that comprises in one non-limiting embodiment less than about 26 fan blades 42. In another non-limiting embodiment, the fan section 22 includes less than about 20 fan blades 42. Moreover, in one disclosed embodiment the low pressure turbine 46 includes no more than about 6 turbine rotors schematically indicated at 34. In another non-limiting example embodiment, the low pressure turbine 46 includes about 3 turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

Fuel is delivered to the combustor 56 by a fuel system 62. The example fuel system 62 includes a primary system 66 and a back-up or secondary system 68. Fuel from a fuel tank 64 is pumped to a desired pressure and provided to the combustor 56. The disclosed fuel system 62 tailors a flow of fuel 70 to the combustor 56 based on engine operating conditions. Instead of simply providing a fuel flow that provides for extremes of operating demands, the disclosed fuel system 62 varies the flow of fuel 70 according to a demand for fuel. By tailoring the flow of fuel to engine operating demand, a fuel recirculation loop for excess fuel can be reduced and/or eliminated.

Fuel is utilized as a heat sink to cool other flows within the engine such as lubricant and air flows. In this example, a heat fuel/oil heat exchanger 65 cools a flow of lubricant generated by a lubricant system 55. Recirculation of fuel results in an increased temperature of the fuel and thereby a reduced capability to accept heat from other engine systems, such as the example lubricant system 55.

The disclosed fuel system 62 varies the flow of fuel 70 based on demand to reduce and/or eliminate the recirculation of fuel and thereby increase the ability to accept heat from other engine systems.

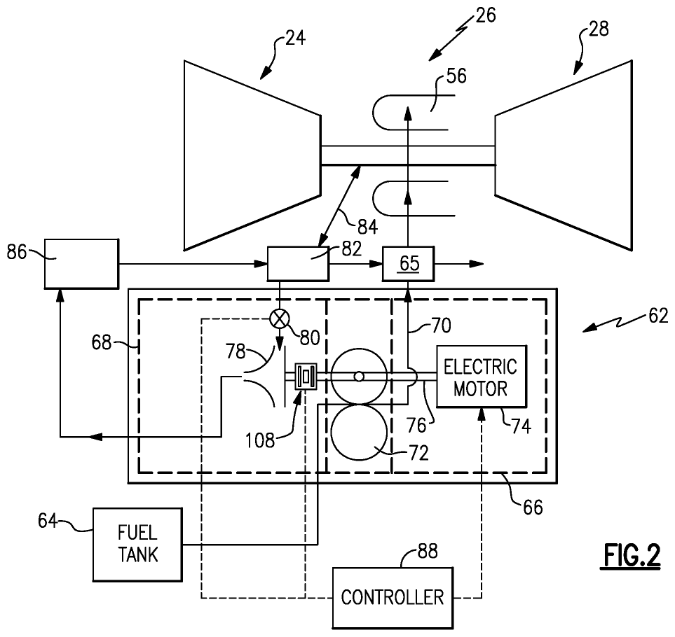

Referring to FIG. 2 with continued reference to FIG. 1, the example fuel system 62 includes a primary fuel pump 72 that generates the flow of fuel 70 during engine operation. The primary fuel pump 72 is driven by an electric motor 74 coupled to the primary fuel pump 72 by a shaft 76. The electric motor 74 is controlled by a controller 88 that varies a speed of the motor 74 to drive the primary pump 72 in a variable manner to match engine fuel demand. It is desirable to provide a back-up system to provide an uninterrupted flow of fuel 70 in the event operation of the electric motor is disrupted. The example fuel system 62 includes the secondary system 68 to continue the flow of fuel 70 in the event the electric motor is unable to drive the primary fuel pump 72.

The secondary system 68 includes a hydraulically powered turbine 78 coupled to the shaft 76 to drive the primary fuel pump 72 independent of the electric motor 74. In the disclosed example, a clutch 108 is provided to selectively couple the turbine 78 to the shaft 76. The clutch 108 may be decoupled while the electric motor 74 operates the primary fuel pump 72. In instances where the electric motor 74 is not driving the primary fuel pump 72, the clutch 108 may be actuated to couple the turbine 78 to the shaft 76 and drive the primary pump fuel 72.

In the disclosed example, the turbine 78 is driven by hydraulic fluid flow produced by a hydraulic pump 84 receiving hydraulic fluid from a hydraulic system schematically indicated at 86. The hydraulic system 86 may be a dedicated system for providing a back-up drive for the fuel system 62. The hydraulic system 86 may also be part of other engine systems that provide hydraulic power to hydraulic actuators or other hydraulic devices existing on the engine or aircraft. The pump 82 maybe operated through a mechanical connection schematically shown at 84 to a rotating shaft driven by the turbine section 28. The connection 84 may also be to an accessory gearbox or other mechanically coupled device provided on the engine 20.

A hydraulic control valve 80 controls operation of the turbine 78. The control valve 80 may normally be in a closed condition such that the turbine 78 is not driven. Opening of the control valve 80 generates hydraulic flow that powers the turbine 78. Operation of the control valve 80 is governed by the controller 88 to vary a flow of hydraulic fluid to the hydraulic turbine 78 to thereby control a speed of the turbine 78 and thereby the speed of the primary pump 72 and the flow of fuel 70. The hydraulic turbine 78 may be part of lubricant system or a hydraulic system already existing and part of the engine and aircraft.

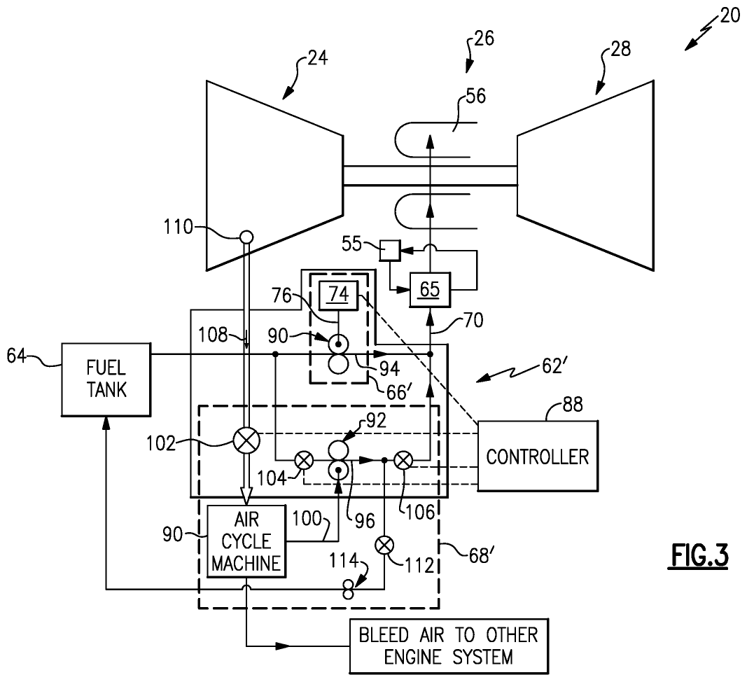

Referring to FIG. 3, with continued reference to FIG. 1, another example fuel system embodiment is schematically shown and indicated at 62′. The example fuel system 62′ includes a secondary system 68′ that includes a secondary pump 92 powered by a secondary drive 98. In this disclosed example, the secondary drive 98 is an air cycle machine driven by bleed airflow 108 drawn from a tap 110 from the compressor section 24 of the engine 20.

The air cycle machine 98 is driven by the bleed airflow 108 obtained from the compressor location 110. The air cycle machine uses the bleed airflow 108 for other aircraft systems including environmental control system and cooling systems for hot sections of the engine 20. The air cycle machine 98 is coupled to a secondary pump 92 by a shaft 100, shown schematically. The secondary pump 92 is disposed in a secondary passage 96 including a first control valve 104 upstream of the secondary pump 92 and a second control valve 106 downstream of the secondary pump 106. Fuel flow within the secondary passage 96 is closed during routine operation of the primary fuel pump 90. A bleed air control valve 12 controls operation and speed of the air cycle machine and thereby of the shaft 100 diving the secondary pump 92.

Because the air cycle machine 98 is operable during engine operation to provide bleed airflow to other engine systems, the mechanical connection through the shaft 100 continually drives the secondary pump 92. However, because the control valves 104 and 106 are normally in a closed position, the secondary pump 92 is not in communication with fuel and does not contribute to fuel flow to the combustor 56. An evacuation system pump 114 is in selective communication with the secondary passage 96 to exhaust fuel from the secondary pump 92 when not in use. In one disclosed example, a control valve 112 controls communication between the evacuation system 114 and the secondary passage 96. Once the control valves 104 and 106 are closed, the control valve 112 opens to enable the evacuation system 114 to evacuate fuel back to the fuel tank 64. The evacuation system 114 could then be turned off once fuel is evacuated from the secondary pump 92 and the secondary passage 96.

In the event that the electric motor 74 is no longer able to drive the primary fuel pump 90 and thereby provide fuel flow through the first fuel passage 94, the first and second control valves 104 and 106 are opened to allow the secondary pump 92 to supply a flow of fuel to the combustor 56. The flow of fuel provided by the secondary fuel pump 92 can be varied by adjusting a flow of bleed airflow with the bleed air control valve 102.

Operation of the engine 20 with reference to the Figures is therefore provided according to a disclosed method of supplying fuel to the combustor 56 by driving the primary fuel pump 72, 90 with the electric motor 74 to provide the fuel flow 70 that varies independent of a speed of the shafts 40, 50 driven by the turbine section 28. Because the pump 72, 90 is not mechanically coupled to the shafts 40, 50, the pump 72, 90 can be operated in a variable manner based on a demand for fuel. Accordingly, the flow of fuel can be reduced for applicable engine operating conditions to reduce and/or eliminate the need for recirculation of excess fuel flow. The decoupling of the engine speed from fuel flow enables an improved match between pump operation and actual demand of fuel flow. The reduced or eliminated recirculation of excess of fuel reduces the overall temperature of the fuel flow and thereby increases the heat acceptance capacity of the fuel flow.

In the event that the electric motor 74 becomes incapable of driving the primary pump 72, 90, the disclosed secondary systems 68, 68′ provide for the generation of a second fuel flow by either driving the primary fuel pump 72, or driving a secondary fuel pump 90. A secondary drive in the form of a hydraulically powered turbine 78 or an air cycle machine 98 provide the power to continue the flow of fuel 70 to the combustor 56.

Accordingly, the disclosed fuel systems provide a varied flow to match engine demand during operation that enables an increased heat acceptance capacity of the fuel while maintaining operation with a secondary drive system to assure uninterrupted fuel flow.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A fuel system for a gas turbine engine comprising:
a primary fuel pump providing fuel flow during engine operation;
a primary electric motor coupled to the primary fuel pump for driving the primary fuel pump during engine operation; and
a secondary system providing fuel flow in the absence of fuel flow from the primary fuel pump.

2. The fuel system as recited in claim 1, wherein the secondary system comprises a secondary drive coupled to the primary fuel pump for driving the fuel pump instead of the electric motor.

3. The fuel system as recited in claim 2, wherein the secondary drive comprises a hydraulic turbine coupled to the primary pump.

4. The fuel system as recited in claim 3, including a clutch means for selectively coupling the hydraulic turbine to drive the primary pump.

5. The fuel system as recited in claim 3, including a hydraulic control valve controlling a flow of hydraulic fluid to the hydraulic turbine to control a speed of the hydraulic turbine and thereby the speed of the primary pump and the flow of fuel.

6. The fuel system as recited in claim 1, wherein secondary system comprises a secondary pump powered by a secondary drive.

7. The fuel system as recited in claim 6, wherein the secondary drive comprises a hydraulically powered turbine.

8. The fuel system as recited in claim 6, wherein the secondary drive comprises an air cycle machine driven by a bleed airflow from the engine.

9. The fuel system as recited in claim 8, including a bleed air control valve controlling a speed of the air cycle machine.

10. The fuel system as recited in claim 9, including a first valve upstream of the secondary pump and a second valve downstream of the secondary pump for controlling fuel flow from the secondary pump.

11. A gas turbine engine comprising:
a fan rotatable within a fan nacelle;
a core engine including a compressor communicating compressed air to a combustor where compressed air is mixed with fuel and ignited to generate a high-energy gas flow expanded through a turbine;
a primary fuel pump providing fuel to the combustor during engine operation;
a primary electric motor coupled to the primary fuel pump for driving the primary fuel pump during engine operation; and
a secondary system providing fuel flow in the absence of fuel flow from the primary fuel pump.

12. The gas turbine engine as recited in claim 11, wherein the secondary system comprises a hydraulically powered turbine coupled to drive the primary fuel pump instead of the primary electric motor.

13. The gas turbine engine as recited in claim 12, including a hydraulic control valve controlling a flow of hydraulic fluid to the hydraulic turbine to control a speed of the hydraulic turbine and thereby the speed of the primary pump and the flow of fuel to the combustor.

14. The gas turbine engine as recited in claim 11, wherein secondary system comprises a secondary pump powered by a secondary drive.

15. The gas turbine engine as recited in claim 14, wherein the secondary drive comprises a hydraulic turbine driven by a flow of fluid.

16. The gas turbine engine as recited in claim 15, wherein the hydraulic turbine comprise an air cycle machine driven by a flow of air bled from the compressor and a bleed air control valve controlling a speed of the air cycle machine by varying the flow of air bleed from the compressor.

17. The gas turbine engine as recited in claim 16, including a first valve upstream of the secondary pump and a second valve downstream of the secondary pump for controlling fuel flow from the secondary pump.

18. A method of supplying fuel to a combustor of a gas turbine engine comprising:
driving a primary fuel pump with an electric motor to provide a first fuel flow that varies independent of a speed of shaft driven by a turbine of the engine; and
generating a second fuel flow with a secondary system in response to the electric motor not driving the primary fuel pump sufficiently to power the engine.

19. The method as recited in claim 18, including generating the second fuel flow with a secondary drive driving the primary fuel pump.

20. The method as recited in claim 18, including generating the second fuel flow with a secondary fuel pump driven by a secondary drive independent of the primary fuel pump.

21. The method as recited in claim 20, wherein the secondary drive comprises an air cycle machine powered by a flow of air bleed from a compressor of the engine.
